(19) United States
(12) Patent Application Publication
(10) Pub. No.: US 2019/0299318 A1
(43) Pub. Date: Oct. 3, 2019

(54) WELDING ROD SUPPLY SYSTEM

(71) Applicant: Eberspächer Exhaust Technology GmbH & Co. KG, Neunkirchen (DE)

(72) Inventors: Mark DONAUER, Schiffweiler (DE); Uwe DIEHL, Schiffweiler (DE)

(21) Appl. No.: 16/365,981

(22) Filed: Mar. 27, 2019

(30) Foreign Application Priority Data
Mar. 28, 2018 (DE) 10 2018 107 404.2
Jun. 20, 2018 (DE) 10 2018 114 754.6

(51) Int. Cl. B23K 9/12

(52) U.S. Cl. CPC B23K 9/124; B23K 9/1336; B23K 9/122

(57) ABSTRACT

A welding rod supply system for a welding unit, especially for a welding robot, includes a welding rod supply unit (12) to be coupled with a welding torch (14). The welding rod supply unit (12) includes a rod guide duct (18) formed therein as well as at least two welding rod-receiving cables (22, 24). The at least two welding rod-receiving cables (22, 24) adjoin the welding rod supply unit (12) and are each to be coupled with a welding rod feed unit and are each associated with a rod guide duct (26, 28) formed therein.

### CROSS REFERENCE TO RELATED APPLICATIONS

This application claims the benefit of priority under 35 U.S.C. § 119 of German Applications 10 2018 107 404.2, filed Mar. 28, 2018, and 10 2018 114 754.6, filed Jun. 20, 2018, the entire contents of which are incorporated herein by reference.

### TECHNICAL FIELD

The present invention pertains to a welding rod supply system, with which a welding rod can be fed to a welding torch in a welding unit, especially in a welding robot. The present invention pertains, in particular, to a welding rod supply system, which is to be provided in a hollow shaft welding robot, and in which different welding rods can alternatingly be fed to a welding torch.

### BACKGROUND

Such a welding rod supply system comprises, in general, a torch cable with a rod guide duct, which is formed in it in a rod core and in which a welding rod is fed by a welding rod feed unit in the direction of a welding torch. The torch cable is coupled with the welding torch in a welding torch coupling area and is coupled with a feed unit feeding the welding rod into the rod feed duct in a feed unit coupling area and is configured flexibly with the rod core configured with a helically wound rod, so that the torch cable can follow the movements of an arm of the welding robot, which arm carries the welding torch.

### SUMMARY

An object of the present invention is to provide a welding rod supply system, with which a greater variability can be achieved during the use of a welding unit.

This object is accomplished according to the present invention by a welding rod supply system for a welding unit, especially for a welding robot, comprising a welding rod supply unit to be coupled with a welding torch with a rod guide duct formed in it as well as at least two welding rod-receiving cables, which adjoin the welding rod supply unit in a switch area and are to be coupled each with a welding rod feed unit, each with a rod guide duct formed therein.

This welding rod supply system offers the possibility of supplying welding rods fed via the different welding rod-receiving cables by different welding rod feed units to the welding torch. The welding rods pushed by the different welding rod feed units into the respective rod guide ducts of the different welding rod-receiving cables may have different properties, and especially be made of different materials, so that different welding fillers can be made available at the welding torch for carrying out welding operations in a simple manner without having to make any conversions whatsoever.

For a reliable guiding of the welding rods in the rod guide ducts, it is proposed that the rod guide duct be provided in a rod core configured with a helical winding in at least some areas in at least one and preferably each welding rod-receiving cable.

For connection to a welding torch, on the one hand, and to welding rod feed units, on the other hand, it is proposed that the welding rod supply unit have a welding torch coupling area for coupling the welding rod supply unit to a welding torch, and that each welding rod-receiving cable have a feed unit coupling area for coupling the welding rod-receiving cable to a respective welding rod feed unit. These coupling areas may be standard coupling areas, which are usually used in torch cables providing only a single rod guide duct, in order to guarantee a rapid and reliable coupling with the welding torch, on the one hand, and with a welding rod feed unit, on the other hand.

To send the welding current necessary when carrying out a welding operation via the welding rod supply system, a welding current conductor connecting the feed unit coupling area of the welding rod-receiving cable with the welding torch coupling area in an electrically conductive manner may be provided in association with each welding rod-receiving cable.

To ensure that the welding rod necessary for the welding operation can be fed to the welding torch during the welding operation, it is further proposed that the welding rod supply unit be coupled with a welding torch, that a welding rod feed unit each be coupled with a plurality of welding rod-receiving cables and preferably with each welding rod-receiving cable, and that an actuating device be provided for actuating the welding rod feed units such that a welding rod to be fed by one of these welding rod feed units in the direction of the welding torch can be fed to the welding torch through the rod guide duct of the welding rod-receiving cable coupled with this welding rod feed unit over the switch area and the rod guide duct of the welding rod supply unit.

Further, a welding current source that can be actuated by the actuating device may be provided for a configuration requiring only a single welding current source, the actuating device being configured to actuate the welding current source for feeding a welding current via the welding rod feed unit actuated for feeding a welding rod.

To determine whether, in particular, a welding rod is present in the welding rod supply unit and is being pushed to the welding torch, it is proposed that at least one welding rod sensor be provided in association with the welding rod supply unit for the preferably inductive detection of a welding rod extending in the rod guide duct of the welding rod supply unit, wherein at least one welding rod sensor is configured to input a welding rod detection signal into the actuating device.

For a configuration that can be embodied in a simple manner, the switch area may have a switch body with a receiving area open towards the welding rod-receiving cables for receiving the rod cores providing the rod guide ducts of the welding rod-receiving cables.

To make it possible to integrate the system configured according to the present invention in an arm of a welding robot in a simple manner, it is proposed that a longitudinal extension of the switch area be at least twice and preferably at least three times of at least one and preferably each welding rod-receiving cable.

Provisions may be made in this connection according to the present invention for rod guide ducts formed in the welding rod-receiving cables in the switch area be merged into a connection volume leading to the rod supply duct of the welding rod supply unit.

The present invention further pertains to a welding unit, especially to a welding robot, comprising a welding rod supply system having a configuration according to the present invention.

Such a welding unit may have, especially if configured as a welding robot, an arm comprising at least one axis configured as a hollow shaft, wherein a welding torch is provided at an end area of the arm and the welding rod supply unit extending in the inner volume of the arm is coupled with the welding rod-receiving cables at the other end area of the arm.

The present invention will be described below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a welding unit with a welding rod supply system for supplying two welding rods to a welding torch;

FIG. 2 is an enlarged partial sectional view of a switch area of the welding rod supply system in detail II in FIG. 1;

FIG. 3 is a sectional view in the area of the welding rod supply system shown in FIG. 2 with a welding torch coupled therewith; and

FIG. 4 is a sectional view of the welding rod supply system having the configuration shown in FIGS. 1-3, which system is integrated in an arm of a welding robot.

### DESCRIPTION OF PREFERRED EMBODIMENTS

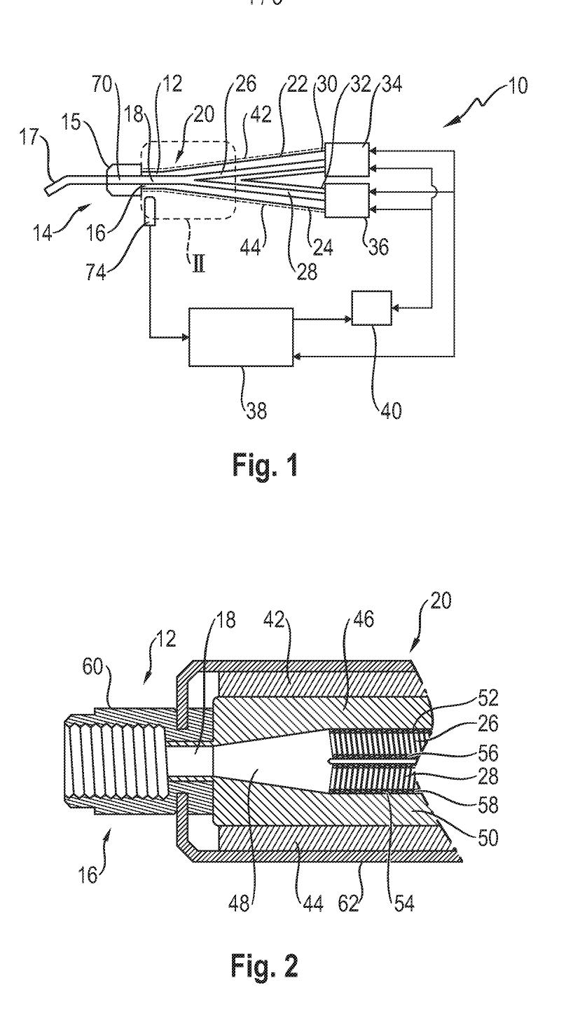

Referring to the drawings, FIG. 1 shows a welding rod supply system generally designated by 10, which can be used in a welding unit, especially in a welding robot. The welding rod supply system 10 comprises a welding rod supply unit 12, via which a welding rod to be used for a welding operation can be inserted into a welding torch 14 shown schematically in FIG. 1. The welding torch 14 may comprise, for example, a torch mount 15 and a torch neck 17 to be inserted into same. A rod guide duct 18 guiding the welding rod in the direction of the welding torch 14 is formed in the welding rod supply unit 12 to be coupled with the welding torch 14 in a welding torch coupling area 16.

Two welding rod-receiving cables 22, 24 adjoin the welding rod supply unit 12 in a switch area 20. A respective rod guide duct 26, 28 each, which is open in the switch area 20 towards the rod guide duct 18 of the welding rod supply unit 12, is provided in each of the two welding rod-receiving cables 22, 24.

The welding rod-receiving cables 22, 24 are coupled with respective welding rod feed units 34, 36 by means of respective feed unit coupling areas 30, 32. Via each of the welding rod feed units 34, 36, a respective welding rod can be pushed into the respective rod guide duct 26, 28 of the welding rod-receiving cable 22, 24 coupled with said rod guide duct and via this duct to the switch area 20 and into the rod guide duct 18 of the welding rod supply unit 12 via mechanisms comprising, for example, feed wheels or the like.

The two welding rod feed units 34, 36 are actuated by an actuating device 38. The actuating device 38 may comprise one or more processors and associated memory. The actuating device 38 is configured to actuate, for operation, one of the two welding rod feed units whose welding rod is needed for the welding operation. Such operation is, i.e., pushing a welding rod into the welding rod-receiving cable coupled therewith, for a particular welding operation to be performed. Provisions may be made, in particular, for welding rods consisting of different materials to be provided and fed into the two welding rod feed units 34, 36, so that different welding rods can also be made available and fed into the welding torch 14 for different welding operations to be carried out.

A welding current source generally designated by 40 is likewise actuated by the actuating device 38. The welding current source can feed, actuated by the actuating device 38, a welding current into the one of the two welding rod feed units 34, 36 that is currently being actuated by the actuating device 38 for feeding welding rod.

In association with each of the two welding rod-receiving cables 22, 24, a welding current conductor 42 and 44, respectively, is provided. This conducts the welding current fed from the current source 40 into the respective welding rod feed unit 34 and 36 actuated for feeding a welding rod to the welding rod supply unit 12 and via this into the welding torch 14.

FIG. 2 shows an enlarged detail II of FIG. 1 with the welding rod supply unit 12 and with the switch area 20. The switch area 20 comprises a switch body 46, in which a connection volume 48 is provided, which leads to the rod guide duct 18 of the welding rod supply unit 12 and tapers in a funnel-shaped manner in the feed direction of a welding rod. In the receiving area 50 oriented in the direction of the welding rod-receiving cables 22, 24, the switch body 46 has two ducts 52, 54, which are open towards the connection volume and into which respective rod cores 56, 58 of the welding rod-receiving cables 22, 24, which cores are configured each with a wound rod and hence in a flexible manner, are inserted or corresponding rod cores extending in the welding rod-receiving cables 22, 24 adjoin the rod cores 56, 58 extending in the switch body 46. The rod guide ducts 26, 28 of the welding rod-receiving cables 22, 24 are provided in these rod cores and are passed on in the switch body 46. The rod guide ducts 26, 28 formed and passed on in the rod cores 56, 58 are open in the switch area 20 towards the rod guide duct 18 of the welding rod supply unit 12 via the connection volume 48 tapering in a funnel-shaped manner.

The welding current conductors 42, 44 conducting the welding current in the direction of the welding torch 14 are also indicated in a schematic view in FIG. 2. These conductors 42, 44 can be in electrically conductive connection with a coupling head 60 of the welding rod supply unit 12 and thus introduce the welding current into the welding torch 14 via the coupling head 60. A sleeve-like housing 62 may be arranged such that it encloses the area in which the rod guide ducts 26, 28 adjoin the rod guide duct 18 and can guarantee a holding together in a stable manner, and the housing 62 can also lock the coupling head 60 at the switch body 50. It can be seen in FIG. 2 that the rod supply duct 18 of the welding rod supply unit 12 may be formed in at least some areas in an end area of the switch body 50, which end area extends into the coupling head 60.

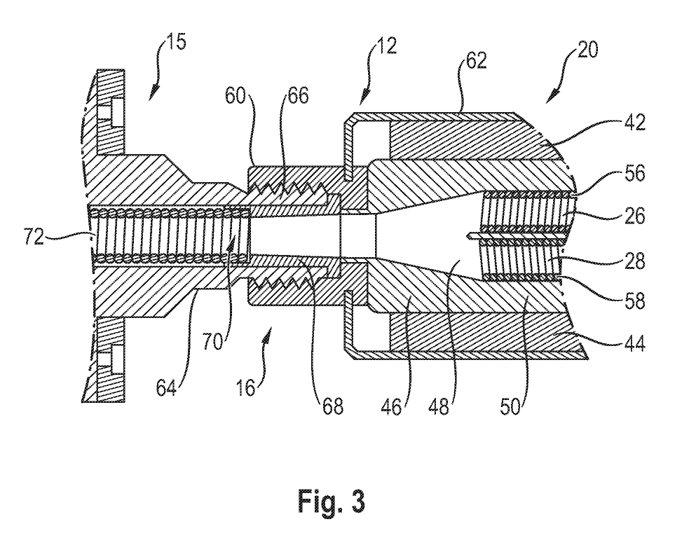

FIG. 3 shows the connection of the welding torch 14, especially of the torch mount 15 thereof, which is shown in some areas, to the welding rod supply unit 12. The torch mount 15 or a connection unit to be coupled with it has a neck-like coupling section 64, which can be inserted with an end section 66 configured with external thread into the coupling head 60 of the welding rod supply unit 12, which coupling head 60 is configured with internal thread. A central opening, into which a transition sleeve 68 is inserted from an end facing the coupling head 60, is provided in the coupling section 64. A section of a rod guide duct 70 of the torch mount 15 and, if present, of a connection unit coupling this torch mount 15, is formed in the transition sleeve 68. This section of the rod guide duct may have, for example, a tapering configuration in the rod feed direction, so that an essentially continuous transition is provided from the rod guide duct 18 of the welding rod supply unit 12 to the section of the rod guide duct 70 of the torch mount 15 or of the connection unit, which section is formed in a rod core 72. It should be noted that the welding torch coupling area 16 of the welding rod supply unit 12, which coupling area 16 is shown in FIGS. 2 and 3, may have a conventional configuration, as it is also used in systems in which only a single rod guide duct is provided for supplying a single welding rod to a welding torch. The feed unit coupling areas 30, 32, with which the two welding rod-receiving cables 22, 24 can be coupled with the welding rod feed units 34, 36, which are to be coupled with them, may correspondingly have a configuration as that used in case of a torch cable application used conventionally, which provides only a single rod guide duct.

To provide information that a welding rod is available and is being fed to the welding torch 14 in a welding rod supply system 10 configured according to the present invention, an inductively operating welding rod sensor 74 may be provided, for example, in the area of the welding rod supply unit 12. If a welding rod being fed through one of the two welding rod feed units 34, 36 is moving in the rod guide duct 18 of the welding rod supply unit 12, the sensor 74 can detect this movement. An input of a corresponding detection signal is made into the actuating device 38. Feedback information indicating that the welding rod feed unit actuated by this actuating device is feeding a welding rod in the direction of the welding torch 14 in a correct manner is made available to the actuating device.

To simplify the integration into a welding unit, especially a welding robot, the welding rod supply system 10 may be configured, especially also in the area of the two welding rod-receiving cables 22, 24, with a cover or a jacket, in which the two welding rod-receiving cables 22, 24 and the rod guide ducts formed therein extend. This jacket may end at a short distance in front of the feed unit coupling areas 30, 32, so that the two welding rod-receiving cables 22, 24 can then extend independently from one another to the respective welding rod feed unit 34, 36 to be coupled with them. The welding rod supply unit 12 may also have between the switch area 20 and the coupling head 60 a flexible, cable-like length section, which may correspond in terms of its configuration, for example, to the configuration of the welding rod-receiving cables 22, 24. In case of such a configuration, the switch area 20 is located farther away from the welding torch coupling area 16 than in the embodiment shown in FIG. 1.

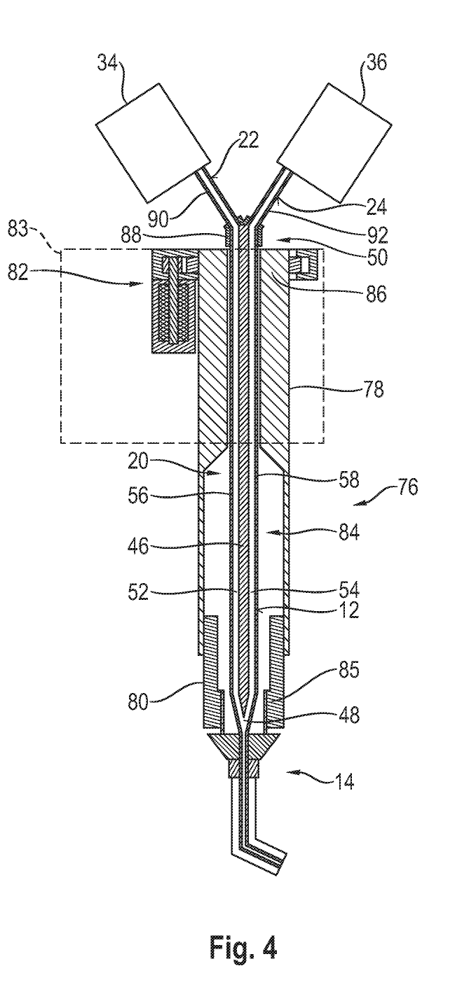

Another embodiment of the welding rod supply system 10, which makes possible a simple integration of this system into an arm 76 of a welding robot, is shown in FIG. 4. The welding rod supply system 10 shown in FIG. 4 is configured such that compared to the schematic view shown in FIG. 1, there is a markedly greater length section, in which the two rod cores 56, 58 and the rod guide ducts 26, 28 formed therein are merged in the welding rod supply unit 12 in order to form a structurally standardized, tube-like area, which may be arranged such that it extends in the interior of the arm 76.

The fifth axis 78 configured as a hollow shaft and the sixth axis 80 of the arm 76, which latter axis is arranged coaxially thereto and is likewise configured as a hollow shaft, are shown as examples in FIG. 4. The area of the arm 76, which is not shown in detail in FIG. 4 and in which the fifth axis is carried rotatably via, for example, a mechanism 82, is generally designated by 83 in FIG. 4.

The standardized length section 84 of the welding rod supply unit 12 extends in the inner volume area of the two axes 78, 80 configured as hollow shafts. This length section 84 is provided essentially by the switch area 20, which has a correspondingly longer configuration, with a switch body 46 providing the connection volume 48, on the one hand, and the ducts 52, 54, which are open towards the connection volume 48, on the other hand. The switch body 46 is dimensioned such that it extends almost along the entire inner volume area of the axes 78, 80. The welding torch 14 is carried on the arm 76 at an end area 85 of the arm 76, which arm is formed in the area of the sixth axis 80. At an end area 86 of the arm 76 or of the fifth axis 78, which area or axis is located away from the sixth axis 80, the length section 84 exits from the arm 76 or the fifth axis 78 thereof and has in this area the receiving area 50, in which the rod cores 56, 58, which also extend, for example, in the welding rod-receiving cables 22, 24, are inserted into the ducts 52, 54 of the switch body 46, or corresponding rod cores or the like of the welding rod-receiving cables 22, 24 adjoin or are connected to the rod cores 56, 58 extending in the switch body 46. The switch body 46 may be connected to a respective jacket 90, 92 of the welding rod-receiving cables 22, 24 in a mechanically stable manner in the area of a connection piece 88, which is positioned, for example, outside the arm 76. The respective welding current conductors 42, 44 provided in association with the welding rod-receiving cables 22, 24 can also be inserted in the area of the connection piece 88 from the welding rod-receiving cables 22, 24 into the length area 84, i.e., essentially also into the switch area 20.

It appears from the above description that in the sense of the present invention, the switch area 20 provides the length area of the welding rod supply unit 12, in which, on the one hand, the two or more than two welding rod-receiving cables 22, 24 and the respective rod guide ducts 26, 28 formed in them are merged and then extend in a standardized body, namely, in the switch body 46, until they pass over at the other end of the switch area into the connection volume 48, through which the respective welding rod to be used for a welding operation to be carried out is guided to the welding torch 14. In the exemplary embodiment shown in FIG. 1, this length area is comparatively short, for example, shorter than the length area in which the two welding rod-receiving cables 22, 24 extend as assembly units configured basically as mutually separate assembly units, but may optionally be held together by enveloping with a jacket. In the exemplary embodiment shown in FIG. 4, the longitudinal extension of the switch area 20, in which the rod guide ducts 26, 28 and the rod cores 56, 58 providing these extend in the switch body 46, is markedly longer than the longitudinal extension of the welding rod-receiving cables 22, 24 leading from the receiving area 50 or from the connection piece 88 to the respective welding rod feed units 34, 36. This longitudinal extension of the length section 84 providing essentially the switch area 20 may be, for example, at least twice and preferably at least three times the longitudinal extension of the welding rod-receiving cables 22, 24 leading to the welding rod feed units 34, 36.

While specific embodiments of the invention have been shown and described in detail to illustrate the application of the principles of the invention, it will be understood that the invention may be embodied otherwise without departing from such principles.

What is claimed is:

1. A welding rod supply system for a welding unit having a welding torch and welding rod feed units, the welding rod supply system comprising:
a welding rod supply unit to be coupled with the welding torch;
a rod guide duct formed in the welding rod supply unit; and
at least two welding rod-receiving cables to be coupled with the welding rod feed units, the welding rod-receiving cables adjoining the welding rod supply unit in a switch area, and at least one of the welding rod-receiving cables forming a cable rod guide duct connected to the rod guide duct formed in the welding rod supply unit.

2. A welding rod supply system in accordance with claim 1, wherein the cable rod guide duct is provided in a rod core configured with a helical winding in at least some areas.

3. A welding rod supply system in accordance with claim 2, wherein the switch area comprises a switch body with a receiving area open towards the at least one of the welding rod-receiving cables for receiving the rod cores provided via the rod guide duct of the welding rod-receiving cables.

4. A welding rod supply system in accordance with claim 1, wherein:
each of the welding rod-receiving cables forms a cable rod guide duct connected to the rod guide duct formed in the welding rod supply unit;
the welding rod supply unit has a welding torch coupling area for coupling the welding rod supply unit with the welding torch; and
each welding rod-receiving cable has a feed unit coupling area for coupling the welding rod-receiving cables with a respective welding rod feed unit.

5. A welding rod supply system in accordance with claim 4, wherein each welding rod-receiving cable further comprises a welding current conductor electrically conductively connecting the respective feed unit coupling area with the welding torch coupling area.

6. A welding rod supply system in accordance with claim 4, wherein the switch area comprises a switch body with a receiving area open towards the at least one of the welding rod-receiving cables for receiving the rod cores provided via the rod guide duct of the welding rod-receiving cables.

7. A welding rod supply system in accordance with claim 3, wherein the cable rod guide ducts formed in the welding rod-receiving cables are merged in the switch area into a connection volume leading to the rod supply duct of the welding rod supply unit.

8. A welding rod supply system comprising:
a welding torch; and
a welding rod supply unit coupled with the welding torch;
a rod guide duct formed in the welding rod supply unit;
a plurality of welding rod-receiving cables adjoining the welding rod supply unit in a switch area, the welding rod-receiving cables forming a cable rod guide duct connected to the rod guide duct formed in the welding rod supply unit;
welding rod feed units coupled with the plurality of welding rod-receiving cables; and
an actuating device for actuating the welding rod feed units such that a welding rod to be fed by one of these welding rod feed units in the direction of the welding torch can be fed through the rod guide duct of the welding rod-receiving cable coupled with this welding rod feed unit over the switch area and the rod guide duct of the welding rod supply unit to the welding torch.

9. A welding rod supply system in accordance with claim 8, wherein:
wherein each welding rod-receiving cable further comprises a welding current conductor electrically conductively connecting the respective feed unit coupling area with the welding torch coupling area; and
a welding current source is actuated by the actuating device, wherein the actuating device is configured to actuate the welding current source for feeding a welding current via the welding rod feed unit actuated to feed a welding rod.

10. A welding rod supply system in accordance with claim 8, further comprising least one welding rod sensor connected with the welding rod supply unit, wherein:
the at least one welding rod sensor is configured for inductive detection of a welding rod extending in the rod guide duct of the welding rod supply unit; and
the at least one welding rod sensor is further configured for input of a welding rod detection signal into the actuating device.

11. A welding rod supply system in accordance with claim 10, wherein:
each cable rod guide duct is provided in a rod core configured with a helical winding in at least some areas; and
the switch area comprises a switch body with a receiving area open towards the welding rod-receiving cables for receiving the rod cores provided via the rod guide ducts of the welding rod-receiving cables.

12. A welding rod supply system in accordance with claim 8, wherein a longitudinal extension of the switch area is at least twice, a longitudinal extension of each welding rod-receiving cable.

13. A welding rod supply system in accordance with claim 8, wherein the cable rod guide ducts formed in the welding rod-receiving cables are merged in the switch area into a connection volume leading to the rod supply duct of the welding rod supply unit.

14. A welding unit comprising:
a welding rod supply system comprising:
a welding rod supply unit to be coupled with the welding torch;
a rod guide duct formed in the welding rod supply unit; and
at least two welding rod-receiving cables to be coupled with the welding rod feed units, the welding rod-receiving cables adjoining the welding rod supply unit in a switch area, and at least one of the welding rod-receiving cables forming a cable rod guide duct connected to the rod guide duct formed in the welding rod supply unit.

15. A welding unit in accordance with claim 14, further comprising:
a welding torch; and
an arm comprising at least one axis configured as a hollow shaft with an inner volume, wherein the welding torch is provided at an end area of the arm and the welding rod supply unit extends in the inner volume of the arm and is coupled with the welding rod-receiving cables at another end area of the arm.

16. A welding unit in accordance with claim 15, further comprising:
welding rod feed units coupled with the plurality of welding rod-receiving cables; and
an actuating device for actuating the welding rod feed units such that a welding rod to be fed by one of these welding rod feed units in the direction of the welding torch can be fed through the rod guide duct of the welding rod-receiving cable coupled with this welding rod feed unit over the switch area and the rod guide duct of the welding rod supply unit to the welding torch.

17. A welding unit in accordance with claim 16, wherein:
a welding current source is actuated by the actuating device, wherein the actuating device is configured to actuate the welding current source for feeding a welding current via the welding rod feed unit actuated to feed a welding rod.

18. A welding unit in accordance with claim 17, further comprising least one welding rod sensor connected with the welding rod supply unit, wherein:
the at least one welding rod sensor is configured for inductive detection of a welding rod extending in the rod guide duct of the welding rod supply unit; and
the at least one welding rod sensor is further configured for input of a welding rod detection signal into the actuating device.

19. A welding unit in accordance with claim 14, wherein:
each of the welding rod-receiving cables forms a cable rod guide duct connected to the rod guide duct formed in the welding rod supply unit;
the welding rod supply unit has a welding torch coupling area for coupling the welding rod supply unit with the welding torch; and
each welding rod-receiving cable has a feed unit coupling area for coupling the welding rod-receiving cables with a respective welding rod feed unit.

20. A welding unit in accordance with claim 19, wherein:
each welding rod-receiving cable further comprises a welding current conductor electrically conductively connecting the respective feed unit coupling area with the welding torch coupling area; and
the switch area comprises a switch body with a receiving area open towards the at welding rod-receiving cables for receiving the rod cores provided via the rod guide duct of the welding rod-receiving cables.
